(19) United States
(12) Patent Application Publication
(10) Pub. No.: US 2008/0171835 A1
(43) Pub. Date: Jul. 17, 2008

(54) Method of sulfonation of polymer substrate to impart a hydrophilic layer in said substrate with improvement in at least one of anti-fog, anti-static, wettability, lubricity anti-microbial properties, and articles made thereby

(75) Inventors: Elena Sebe, West Bloomfield, MI (US); Dwayne Back, Clawson, MI (US); Charles H. Winter, Bloomfield Hills, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Sulfo Technologies, LLC, Madison Heights, MI (US)

(21) Appl. No.: 11/748,252

(22) Filed: May 14, 2007

Related U.S. Application Data
(60) Provisional application No. 60/885,091, filed on Jan. 16, 2007.

(51) Int. Cl. C08F 8/34; C08G 4/00; C08G 63/91; C08G 69/26; C08G 75/20

(52) U.S. Cl. 525/344; 525/418; 525/535; 526/238.21; 526/301; 526/310; 526/312; 528/381

(57) ABSTRACT

A sulfonation method to treat a polymer substrate to provide a hydrophilic layer with an improvement in at least one of anti-fogging, anti-static, wettability, lubricity, anti-microbial and/or transparency properties. The articles formed thereby find excellent application in a wide range of areas.

### CROSS-REFERENCE TO RELATED APPLICATIONS

This application claims the benefit of U.S. Provisional Application Ser. No. 60/885,091 filed Jan. 16, 2007, which is incorporated herein in its entirety.

### BACKGROUND OF THE INVENTION

1. Field of the Invention

The present invention is directed to a method for sulfonating polymer substrates to impart a hydrophilic layer in said substrate to impart improvement in at least one of anti-fogging, anti-static, wettability, lubricity and/or anti-microbial properties.

The present invention is further directed to polymer substrates having a hydrophilic layer obtained by sulfonation to impart improvement in at least one of anti-fogging, anti-static, wettability, lubricity and/or anti-microbial properties of such polymer substrates.

The present invention further relates to a method of sulfonating clear polymer substrates to impart a hydrophilic layer in said substrate exhibiting improved at least one of anti-fogging, anti-static, wettability, lubricity and/or anti-microbial properties without substantially affecting the transparency of said treated polymer substrate.

The present invention further relates to articles made from clear polymer substrates treated with a sulfonation process to impart a hydrophilic layer in said substrate that imparts improvement in at least one of anti-fogging, anti-static, wettability, lubricity and/or anti-microbial properties without substantially affecting the transparency of said articles.

2. Description of the Related Art

Polymer substrates and articles made therefrom commonly exhibit static and fogging properties that affect their usefulness in many applications to which they are used. In addition, under certain conditions, the lubricity and anti-microbial properties of polymers used for medical and packaging uses can be improved to increase their usefulness in medical and packaging fields. Moreover, wettability becomes an issue for many applications and has an effect on many of the properties of the polymer. For example, the phenomenon commonly called fogging is observed widely in various applications of transparent polymer films or sheets. The term fogging describes the condensation of water vapor from air, in the form of discrete water droplets, on a polymer surface. In such situations, light transmitted through polymers that suffer from “fogging” is scattered by the water droplets accumulated on the surface of the polymer, causing the view to be hindered. Polymers are generally non-polar compounds that repel water to a certain degree, according to their surface tension. When affinity of the condensate for the substrate is high, the contact angles between the droplets and the substrate surface are low and very little fogging occurs. In addition, two other key factors influencing the fogging phenomenon are the level of moisture in the air and the difference in temperature between the air and the polymer part. One route that has been widely used to help minimize fogging is improving the wetting performances of the polymer. Wettable surfaces allow liquid films to form at their surfaces instead of droplets. In this case, the contact angles are very low and the transmittance of light and formation of images are not prevented. Typical anti-fogging additives contain molecules composed of both a hydrophilic part that is attracted by water, and a long hydrophobic part, such as a lipophilic part, adapted to the polymer substrate, such as esters of fatty esters. Another common method employed in combating fogging is through temporary or permanent coatings. While it has been known that polymers can be sulfonated to have increased anti-static properties, there have been no studies of using sulfonation to obtain anti-fog, wettable transparent layers that have improved anti-static, anti-fogging, anti-microbial, improved wettability and improved lubricity. Moreover, when polymers, in the form of powders, are used in paints or other mixtures they must exhibit some degree of wettability in order to be useful. In some applications such as paints and retarding additives for cements, polymer powders are added and then a substantial amount of surfactant must be added to permit the polymers to be sufficiently wetted to form a useful composition. The improved wettability of the sulfonated powders in the present invention substantially reduces the amount of surfactant in such compositions to impart the same or improved properties.

Patchen, U.S. Pat. No. 6,923,997 discloses anti-fogging compositions and methods of using the same. Various compositions for food packaging uses are disclosed. For example, one composition of the anti-fogging composition is (i) a nonionic surfactant blend comprising a fatty acid ester and an ethoxylated compound and (ii) acetone. Another example is an anti-fogging nonionic surfactant blend comprising a fatty acid ester and an ethoxylated compound and (ii) a solvent selected from methyl acetate, isopropyl alcohol, ethanol, and mixtures thereof. The method of defogging the food packaging surface entails selecting a surfactant, providing (i) an anti-fogging nonionic surfactant blend comprising a fatty ester and an ethoxylated compound and applying the anti-fogging composition to the surface. Another method disclosed comprises selecting a surface, providing an anti-fogging nonionic surfactant blend comprising a fatty acid ester and an ethoxylated compound and (ii) a solvent selected from methyl acetate, isopropyl alcohol, ethanol, and mixtures thereof to form an anti-fogging composition, and applying the anti-fogging composition to the surface.

Bates, U.S. Pat. No. 6,706,389 discloses a packaging film that includes a heat sealable layer coated with one or more anti-fogging agents disposed on a binder; an anti-blocking agent, and no more than about 800 ppm slip agent. The heat sealable layer includes a polymer that includes mer units derived from ethylene while the binder includes a polymer that includes mer units derived from an ester of (meth)acrylic acid and/or vinyl acetate mers. The anti-blocking agent can be in any layer of the film where it provides the desired anti-fogging effect. Such a film, as well as packaging made therefrom, can be used to package a variety of products, having particular utility with respect to most products.

Dixon, U.S. Pat. No. 2,272,831 discloses a sulfonation of clear polystyrene to impart anti-static properties to a surface of a treated substrate without substantially affecting the surface appearance and transparency of the polystyrene substrate. The sulfonation occurs by the exposure of the surface of a polystyrene substrate to concentrated sulfuric acid solutions.

Walles, U.S. Pat. No. 3,959,561 discloses a method for the rapid rendering of transparent polymer articles astatic by treating the articles with gaseous sulfur trioxide (SO₃) followed by treatment with a base such as ammonia and water or dilute aqueous ammonia. The articles are rendered permanently astatic without affecting their transparency.

### SUMMARY OF THE INVENTION

In one aspect the present invention is a method for the preparation of a polymer substrate with at least one of improved anti-fogging, anti-static, wettability, lubricity and/or anti-microbial properties, comprising treating a polymer substrate in a dry atmosphere with a sufficient concentration of SO₃ for a sufficient time to form a hydrophilic layer in said substrate, and substantially eliminating contact of said SO₃ with said substrate when a desired treatment of said polymer substrate has occurred to form a hydrophilic layer with at least one of said improved properties.

In another aspect, the present invention is a hydrophilic polymer substrate layer obtained by sulfonation with the formula:

P-X
wherein P is a polymer; and
X is a polar functional group;
   wherein said layer imparts at least one of improved anti-fogging, anti-static, lubricity, wettability and/or anti-microbial properties. For purposes of this application, sulfonic groups are included in the definition of polar functional groups as used herein.

The layer formed in a polymer according to the present invention can be imparted to a wide variety of polymer substrates without affecting transparency of the substrate. Accordingly, the process and articles formed according to the present invention find applicability in any areas such as sunglasses, ski and other protection goggles, such as eye or safety goggles, tail light lenses, head lamp lenses, helmet visors, lenses, contact lenses, transparent polymer covers, lids and films. In addition, the invention finds application in medical arts, because substrates treated according to the present invention can be formed into articles such as catheters, intravenous bags, tubing, contact lenses, and valves to be implanted in the body; the articles formed with a hydrophilic layer obtained by sulfonation according to the present invention exhibit at least one of improved lubricity, wettability and anti-microbial properties.

the present invention may be utilized to form polymer pellets and powders that can be used to create other polymer substrates that have the hydrophilic layer obtained by sulfonation infused throughout. In addition, a polymer powder such as an acrylic powder, with a hydrophilic layer obtained by sulfonation can be used in paints or concrete retarding compositions. The improved wettability exhibited by such treated polymer powders can substantially reduce the amount of surfactants in such paints or concrete retarder solutions.

These and other aspects of the invention will become apparent upon a reading of the following specification and examples.

### DETAILED DESCRIPTION OF THE PREFERRED EMBODIMENT(S)

In one aspect, the present invention is a method for the preparation of a polymer substrate with at least one of improved anti-fogging, anti-static wettability, lubricity and anti-microbial properties. The invention includes treating a polymer substrate with a sufficient concentration of SO₃ for a sufficient time to form a hydrophilic layer in said substrate and substantially eliminating contact of said SO₃ with said substrate when a desired treatment of said polymer substrate has occurred to form a hydrophilic layer with at least one of said improved properties.

The sulfonation of the polymer substrate may be conducted in a batch or continuous process. In this regard, reference is made to pending U.S. patent application Ser. No. 11/672,332 entitled “Method of Sulfonating an Article and Related Apparatus” filed Feb. 7, 2007, assigned to the assignee of this application and incorporated herein by reference in its entirety. Specifically, in a batch process, a sulfonating chamber is provided wherein a polymer substrate is placed. Noble gasses such as argon or nitrogen, or dry air are used to purge the chamber and the polymer substrate in order to reduce moisture in the chamber. A sulfonating source, which may be gaseous or liquid, is introduced to the chamber and the substrate therein. The sulfonating source is preferably SO₃, and may be produced by the oxidation of SO₂ in the presence of at least one catalyst, such as, but not limited to V₅O₂ and/or ultraviolet (UV) radiation. Sulfonation reagents also include: fuming sulfuric acid, stabilized SO₃, such as amine stabilized, pyridine stabilized, trimethylsilyl sulfonyl chloride, sodium bisulfate pyrolysis, commercially available SO₃ and mixtures thereof. If in gaseous form, the SO₃ is introduced to said substrate in an amount of from about 0.5% by volume to about 20% by volume for a time period of about 5 seconds to about 30 minutes to form said hydrophilic layer. If in a liquid form, the SO₃ is introduced to the polymer substrate for a time period of from about 1 second to about 10 minutes to form said hydrophilic layer. The reaction may proceed at ambient temperature and pressure. If desired, sufficient heat or UV radiation can be introduced to aid the sulfonation process to form a hydrophilic layer in said substrate. In this regard, it is contemplated that the temperature could range up to the glass transition temperature of the polymer substrate.

In order to improve the treatment of the polymer substrate, the polymer substrate may be exposed to organic solvents prior to sulfonation to enable more facile contact and reaction between the substrate and the SO₃ to permit the hydrophilic layer to be imparted further into said polymer substrate. Examples of solvents can include, but are not limited to, acetone, hexanes and dichloromethane.

The method may further include neutralizing the treated by sulfonation polymer substrate with a base to neutralize any residual sulfonic acid groups or other protic species. A suitable base may be selected from the group consisting of alanine, ammonia, dimethylamine, ethylamine, glycine, hydrazine, methylamine, triethylamine, lithium hydroxide, sodium hydroxide, potassium hydroxide, rubidium hydroxide, cesium hydroxide, magnesium hydroxide, calcium hydroxide, strontium hydroxide, barium hydroxide, salts of weak organic and inorganic acids, metal bicarbonates, metal acid phosphates and diacid phosphates, metal citrates, metal acetates, metal ascorbates, derivates thereof, and mixtures thereof.

Although the advantages of the methods and articles of the present invention are not related to any particular theory, it is hypothesized that during sulfonation, hydrogen atoms and derivatives thereof which are bonded to carbon atoms in the hydrocarbons are replaced by sulfonic acid groups, where they become bonded and form a barrier layer. It may be that the hydrophilic polymer substrate layer obtained by sulfonation can be expressed by the formula:

P-X
wherein P is a polymer; and
X is a polar functional group;
   wherein the layer imparts at least one of improved anti-fogging, anti-static, lubricity, wettability and/or anti-microbial properties. For purposes of this application, sulfonic groups are included in the definition of polar functional groups as used herein.

The bonds of the new layer material are more polar, and therefore, are less likely to allow permeation of hydrocarbons. In one variation, this advantage is realized by using polymeric materials which are sulfonatable by the methods of the present invention. Suitable polymers for sulfonation may be selected from the group consisting of polycarbonates, derivatives of polycarbonates, alkylacrylates, alkylmethacrylates, derivatives of alkyl methacrylates, polyamides, polyimides, polyamido ethers, amido copolymers, polyimidoethers, imido copolymers, derivatives of imido copolymers, cellulosics, derivatives of cellulosics, polysulfones, derivatives of polysulfones, polyesters, copolymers of polyesters, allyl diglycol carbamates, polystyrenes, polystyrene copolymers, derivatives of polystyrene copolymers, vinyl polymers, vinyl copolymers, derivatives of vinyl copolymers, and mixtures thereof.

It is contemplated that the above described method can be used to impart a hydrophilic layer obtained by sulfonation to articles such as catheters, intravenous bags, tubing, contact lenses, and valves to impart improvement in at least one of lubricity and anti-microbial properties to said treated articles.

This method can also be used to impart a hydrophilic layer obtained by sulfonation to articles such as CDs, DVDs, High Definition DVDs, safety goggles, eyeglasses, sunglasses, ski glasses, and other optical media, packaging, contact lenses, automotive head lamp lenses, instrument panels, convertible top rear windows, tail lamp lenses and golf cart windshields to impart improvement in at least one of anti-static and anti-fogging properties to said articles.

Moreover, the method can be used to impart a hydrophilic layer obtained by sulfonation to polymer pellets and powders to impart at least improved wettability. When the powders are acrylic powders used in paints, the use of treated powders substantially reduces the use of surfactants in said paint. In addition the use of treated acrylic powders as concrete retarders substantially reduces the amount of surfactants used in concrete applications, such as oil well applications. When the polymer pellets are treated by sulfonation and subsequently formed into articles, the hydrophilic layer is disbursed throughout the formed polymer substrate.

Objects and advantages of this invention are further illustrated by the following examples. The particular materials and amounts thereof, as well as other conditions and details, recited in these examples should not be used to limit this invention.

### EXAMPLES

Polycarbonate substrates were treated utilizing SO₃ created from a 20% by volume SO₂ feedstock for 30 seconds in dry air up to about 10 minutes at 2% by volume SO₂ feedstock in dry air. The sulfonation chamber was purged with dry air before, between and after the sulfonation steps. The samples were neutralized by rinsing in water, in situ neutralization or with neutralization agents consisting of diluted solutions of weak basic reagents (salts of weak inorganic and organic acids, such as sodium bicarbonate, sodium citrate, sodium acetate) stronger bases such as group I metal hydroxides, ammonia, ammonia water. The samples were tested to determine the anti-fog, wettability, anti-static and visual properties of the polymer substrate with a hydrophilic layer obtained by sulfonation. In order to determine anti-fogging properties, the hydrophilic layer obtained by sulfonation was subjected to fogging by a “hot fog or breath test” and the contact angle of the individual drops of condensed water were measured. The wettability was measured by the formation of water sheets rather than beading when water was applied to the samples. Anti-static was determined by visual inspection to determine whether treated samples attracted dust. Visual properties were determined by visual inspection of the samples after different periods of time or different treatments. All percents are by volume. The results are set forth in the following table.

TABLE 1
Contact Angle Measurements on Pure Polycarbonate (PC) Samples
(All pH values measured at surface of sample)

| | | | | | | Contact |
|---|---|---|---|---|---|---|
| | | | | | Anti-fog | Angles |
| Sample | Sulfonation | Neutralization | Treat/test | visual | Properties | (Avg.) |
| Pure | N/A | N/A | pH 7.0 | Clear | None/fog in | 73.5° |
| PC | | | | | <1 min | |
| 01 | 3 min 5% | N/A; water | 1 wk @ | Clear w/ | Initially | 45.6° |
| | SO₂ | rinse only | 95° C. in | tiny pits | good poor | |
| | feedstock | | oven; pH | before | after oven | |
| | in dry air | | 7.0 | oven; | | |
| | | | | loss of | | |
| | | | | transparency | | |
| | | | | after | | |
| | | | | oven | | |
| 02 | 3 min, 5% | N/A; water | N/A | Clear/w | Good >60 s | 30.6° |
| | vol, SO₂ | rinse only | | tiny pits | hot fog test | |
| | feedstock | | | | | |
| | in dry air | | | | | |
| 03 | 6 min, 5% | 0.1M sodium | N/A | Clear | Excellent | 5.4° |
| | SO₂ | acetate 10 min, | | w/tiny | >60 s hot | |
| | feedstock | Ambient Temp | | pits | fog test | |
| | in dry air | | | | | |
| 04 | 6 min, 5% | 0.1M sodium | N/A | Clear | Excellent | 8.0° |
| | SO₂ | acetate 60 min, | | w/tiny | >60 s hot | |
| | feedstock | Ambient Temp | | pits | fog test | |
| | in dry air | | | | | |
| 05 | 6 min, 5% | 0.1M sodium | N/A | Clear | Excellent | 5.0° |
| | SO₂ | acetate 10 min, | | w/tiny | >60 s hot | |
| | feedstock | Ambient Temp | | pits | fog test | |
| | in dry air | | | | | |
| 06 | 6 min, 5% | 0.1M sodium | N/A | Clear | Excellent | 7.0° |
| | SO₂ | acetate 60 min, | | w/tiny | >60 s hot | |
| | feedstock | Ambient Temp | | pits | fog test | |
| | in dry air | | | | | |
| 07 | 5.5 min, | 0.1M sodium | N/A | Clear | Good >60 s | 30.9° |
| | 2% SO₂ | acetate 10 min, | | w/tiny | hot fog test | |
| | feedstock | Ambient Temp | | pits | | |
| | in dry air | | | | | |
| 08 | 5.5 min, | 0.1M sodium | N/A | Clear | Good >60 s | 31.8° |
| | 2% SO₂ | acetate 10 min, | | w/tiny | hot fog test | |
| | feedstock | Ambient Temp | | pits | | |
| | in dry air | | | | | |
| 09 | 5 min, 2% | 0.1M sodium | N/A | Clear, | Good >60 s | 11.1° |
| | SO₂ | acetate 10 min, | | no pits, | hot fog test | |
| | feedstock | Ambient Temp | | haze or | | |
| | in dry air | | | spots | | |
| 10 | 10 min, 2% | 0.1M sodium | N/A | haze | Good >60 s | 7.9° |
| | SO₂ | acetate 10 min, | | | hot fog test | |
| | feedstock | Ambient Temp | | | | |
| | in dry air | | | | | |
| 11 | 30 s, 20% | 0.1M sodium | 1 wk @ | Clear, | Good >60 s | 24.7 |
| | SO₂ | acetate 10 min, | 95° C. in | no pits | hot fog test | |
| | feedstock | Ambient Temp | closed | haze or | | |
| | in dry air | | cont. pH | spots | | |
| | | | 7.0 | | | |
| 12 | 3 × 20 s, 13% | 0.1M sodium | 1 wk @ | Clear, | Very Good | 8.0° |
| | SO₂ | acetate 10 min, | 95° C. in | no pits | >60 s hot | |
| | feedstock | Ambient Temp | closed | haze or | fog test | |
| | in dry air | | cont. pH | spots | | |
| | | | 7.0 | | | |
| 13 | 3 × 10 s, 13% | 0.1M sodium | 1 wk @ | Clear, | Good | 29.5° |
| | SO₂ | acetate 10 min, | 95° C. in | no pits | | |
| | feedstock | Ambient Temp | closed | haze or | | |
| | in dry air | | cont. pH | spots | | |
| | | | 7.0 | | | |
| 14 | 3 × 20 s, 13% | 0.1M | 1 wk @ | Clear, | Good | 18.8° |
| | SO₂ | bicarbonate sol. | 95° C. in | no pits | | |
| | feedstock | 1 min, Ambient | closed | haze or | | |
| | in dry air | Temp | cont. pH | spots | | |
| | | | 7.0 | | | |
| 15 | 3 min, 5% | 0.1M | 1 wk @ | Clear, | Good | 16.5° |
| | SO₂ | bicarbonate sol. | 95° C. in | no pits | | |
| | feedstock | 6 min, Ambient | closed | haze or | | |
| | in dry air | Temp | cont. pH | spots | | |
| | | | 7.0 | | | |
| 16 | 2 min, 5% | 0.1M | N/A | Clear, | Increased, | 34.1° |
| | SO₂ | bicarbonate sol. | | no pits | but not | |
| | feedstock | 10 min, | | haze or | excellent | |
| | in dry air | Ambient Temp | | spots | | |
| 17 | 1 min, 13% | 0.1M | N/A | Clear, | Good | 31.0° |
| | SO₂ | bicarbonate sol. | | no pits | | |
| | feedstock | 10 min, | | haze or | | |
| | in dry air | Ambient Temp | | spots | | |
| 18 | 4 min, 2% | 0.1M | N/A | Clear, | Increased, | 34.6° |
| | SO₂ | bicarbonate sol. | | no pits | but not | |
| | feedstock | 10 min, | | haze or | excellent | |
| | in dry air | Ambient Temp | | spots | | |
| 19 | 5 min, 2% | 0.1M | N/A | Clear | excellent | 2-4° |
| | SO₂ | bicarbonate sol. | | w/slight | | |
| | feedstock | 10 min, | | hazing | | |
| | in dry air | Ambient Temp | | in some | | |
| | | | | spots | | |
| 20 | 4 min, 2% | 0.1M | Water | Clear no | Increased, | N/A |
| | SO₂ | bicarbonate sol. | soak for 1 | pits haze | but not | |
| | feedstock | 10 min, | week @ | or spots | excellent | |
| | in dry air | Ambient Temp | Ambient | before/after | | |
| | | | temp. | UV | | |
| | | | | test | | |
| 21 | 4 min, 2% | 0.1M | UV | Clear no | Increased, | N/A |
| | SO₂ | bicarbonate sol. | exposure | pits. A | but not | |
| | feedstock | 10 min, | outdoors(no | little | excellent | |
| | in dry air | Ambient Temp | rain, | haze in | | |
| | | | sunny | spots | | |
| | | | weather, T | before/ | | |
| | | | range | after | | |
| | | | between | water | | |
| | | | 40-75° F. | test | | |

As can be seen by reference to Table 1, surface hydrophilicity increased dramatically for polycarbonate samples upon sulfonation. Polycarbonate samples treated by sulfonation can have contact angles that approach 0° while untreated samples have contact angles over 70°.

The breath test, hot fog test, and wettability test show the formation of water sheets instead of beading and constitute additional evidence for increased hydrophilicity and anti-fog properties of polycarbonates treated by sulfonation. Moreover, it was observed that dust and other electrostatically charged particles did not accumulate on polycarbonate surfaces treated by sulfonation as they do on untreated polycarbonate surfaces. Durability of the hydrophilic layer obtained by sulfonation was also demonstrated. Exposure of polycarbonate samples treated by sulfonation to heat in closed or open containers for up to a week did not deteriorate the visual aspect or decrease the anti-fog properties of samples treated by sulfonation if rinsed with a neutralizing solution after sulfonation. Exposure to outdoor UV light for 6 days did not lead to a decrease in anti-fog properties as assessed by wettability, hot fog and breath test. Finally, soaking in water at ambient temperature for 6 days did not lead to a decrease in anti-fog properties, as assessed by wettability, hot fog and breath tests.

While embodiments of the invention have been described and illustrated, it is not intended that these embodiments illustrate and describe all possible forms of the invention. Rather, the words used in the specification are words of description, not words of limitation. It is understood that various changes and modification may be made without departing from the scope and spirit of the invention as set forth in the appended claims.

What is claimed as new and desired to be protected by Letters Patent of the United States is:

1. A method for the preparation of a polymer substrate with at least one of improved anti-fogging, anti-static wettability, lubricity and/or anti-microbial properties, comprising:
treating a polymer substrate with a sufficient concentration of SO₃ for a sufficient time to form a hydrophilic layer in said substrate;
substantially eliminating contact of said SO₃ with said substrate when a desired treatment of said polymer substrate has occurred to form a hydrophilic layer with at least one of said improved properties.

2. The method of claim 1, further including neutralizing said polymer substrate with a base to neutralize any residual sulfonic acid groups and other protic species.

3. The method of claim 2, wherein said base is selected from the group consisting of alanine, ammonia, dimethylamine, ethylamine, glycine, hydrazine, methylamine, triethylamine, lithium hydroxide, sodium hydroxide, potassium hydroxide, rubidium hydroxide, cesium hydroxide, magnesium hydroxide, calcium hydroxide, strontium hydroxide, barium hydroxide, salts of weak organic and inorganic acids, metal bicarbonates, metal acid phosphates and diacid phosphates, metal citrates, metal acetates, metal ascorbates, derivates thereof, and mixtures thereof.

4. The method of claim 1, wherein said polymer substrate is substantially clear, said polymer selected from the group consisting of polycarbonates, derivatives of polycarbonates, alkylacrylates, alkylmethacrylates, derivatives of alkyl methacrylates, polyamides, polyimides, polyamido ethers, amido copolymers, polyimidoethers, imido copolymers, derivatives of imido copolymers, cellulosics, derivatives of cellulosics, polysulfones, derivatives of polysulfones, polyesters, copolymers of polyesters, allyl diglycol carbamates, polystyrenes, polystyrene copolymers, derivatives of polystyrene copolymers, vinyl polymers, vinyl copolymers, derivatives of vinyl copolymers, and mixtures thereof.

5. The method of claim 1, wherein said SO₃ is gaseous or liquid.

6. The method of claim 1, wherein the sulfonation occurs in a dry atmosphere with sufficient SO₃ to form a hydrophilic layer in the substrate.

7. The method of claim 1, wherein said SO₃ is produced by oxidation of SO₂ in the presence of at least one catalyst and/or UV radiation. Sulfonation reagents also include: fuming sulfuric acid, stabilized SO₃, such as amine stabilized, pyridine stabilized, trimethylsilyl sulfonyl chloride, sodium bisulfate pyrolysis, commercially available SO₃, and mixtures thereof.

8. The method of claim 1, wherein said SO₃ is introduced to said substrate in an amount of from about 0.5% by volume to about 20% by volume.

9. The method of claim 1, wherein said substrate is exposed to gaseous SO₃ for a time period of about 5 seconds to about 30 minutes to form said hydrophilic layer.

10. The method of claim 1, wherein said substrate is exposed to liquid SO₃ for a time period of from about 1 second to about 10 minutes to form said hydrophilic layer.

11. The method of claim 1, further including using sufficient heat or UV radiation to aid said sulfonation process to form a hydrophilic layer in said substrate.

12. The method of claim 1, further including the step of exposing the polymer substrate to organic solvents prior to sulfonation to enable more facile contact and reaction between the substrate and the SO₃ to permit the hydrophilic layer to be imparted further into said polymer substrate.

13. The method of claim 1, wherein said hydrophilic layer obtained by sulfonation is imparted to articles such as catheters, intravenous bags, tubing, contact lenses, and valves to impart improvement in at least one of lubricity and antimicrobial properties to said treated articles.

14. The method of claim 1, wherein said hydrophilic sulfonated layer is imparted to articles such as CDs, DVDs, High Definition DVDs, safety goggles, eyeglasses, sunglasses, ski glasses, and other optical media, packaging, contact lenses automotive head lamp lenses, instrument panels, convertible top rear windows, tail lamp lenses and golf cart windshields to impart improvement in at least one of anti-static and anti-fogging properties to said articles.

15. The method of claim 1, wherein said hydrophilic layer obtained by sulfonation is imparted to polymer pellets and powders to impart at least improved wettability.

16. The method of claim 15, wherein said powders are acrylic powders used in paints; treated said powders substantially reducing use of surfactants in paint.

17. The method of claim 15, wherein said powder is acrylic powder used as a retarder in concrete to substantially reduce the use of surfactants in said concrete.

18. The method of claim 1, wherein said preparation may be batch or continuous.

19. A hydrophilic polymer substrate layer with the formula:
P-X
wherein P is a polymer; and
X is any polar functional group
wherein said layer imparts at least one of improved anti-fogging, anti-static, lubricity, wettability and/or anti-microbial properties.

20. The hydrophilic polymer substrate layer of claim 19, wherein X is a sulfonic group.

21. The hydrophilic polymer substrate layer of claim 19, wherein sulfonation of said substrate layer occurs in the presence of heat or UV radiation.

22. The hydrophilic polymer substrate layer obtained by sulfonation of claim 19, wherein said polymer substrate is selected from the group consisting of polycarbonates, derivatives of polycarbonates, alkylacrylates, alkylmethacrylates, derivatives of alkyl methacrylates, polyamides, polyimides, polyamidoethers, amido copolymers, polyimidoethers, imido copolymers, derivatives of imido copolymers, cellulosics, derivatives of cellulosics, polysulfones, derivative of polysulfones, polyesters, copolymers of polyesters, allyl diglycol carbamates, polystyrenes, polystyrene copolymers, derivatives of polystyrene copolymers, vinyl polymers, vinyl copolymers, derivatives of vinyl copolymers, and mixtures thereof.

23. The hydrophilic polymer substrate layer obtained by sulfonation of claim 19, wherein said treated polymer substrate layer is further treated with a base to neutralize any residual sulfonic acid groups and/or other protic species.

24. The hydrophilic polymer substrate layer obtained by sulfonation of claim 22, said base selected from the group consisting of alanine, ammonia, dimethyl amine, ethylamine, glycine, hydrazine, methylamine, triethylamine; lithium hydroxide, sodium hydroxide, potassium hydroxide, rubidium hydroxide, cesium hydroxide, magnesium hydroxide, calcium hydroxide, strontium hydroxide, barium hydroxide, salts of weak organic and inorganic acids, metal bicarbonates, metal acid phosphates, and diacid phosphates, metal citrates, metal acetates, metal ascorbates, and mixtures thereof.

25. The hydrophilic polymer substrate layer obtained by sulfonation of claim 19, wherein said SO₃ is produced by oxidation of SO₂ in the presence of at least one catalyst and/or UV radiation. Sulfonation reagents also include: fuming sulfuric acid, stabilized SO₃, such as amine stabilized, pyridine stabilized, trimethylsilyl sulfonyl chloride, sodium bisulfate pyrolysis, commercially available SO₃, and mixtures thereof.

26. The hydrophilic polymer substrate layer obtained by sulfonation of claim 19, wherein said layer is imparted to articles such as catheters, intravenous bags, contact lenses and valves to impart improved at least one of lubricity, anti-fogging, and anti-microbial properties to said articles.

27. The hydrophilic substrate layer obtained by sulfonation of claim 19, wherein said layer is imparted to articles such as CDs, DVDs, High Definition DVDs, and optical media to impart at least improved anti-static properties to said articles.

28. The hydrophilic substrate layer obtained by sulfonation of claim 19, wherein said layer is imparted to articles such as safety goggles, eyeglasses, sunglasses, packaging, automotive headlamp lenses, instrument panels, convertible top rear windows, tail lamp lenses and golf cart windshields to impart at least improved anti-fogging properties to said articles.

29. The hydrophilic substrate layer obtained by sulfonation of claim 19, wherein said layer is imparted to polymer pellets and powders to impart at least improved wettability to said pellets and powders.

30. The hydrophilic substrate layer obtained by sulfonation of claim 28, wherein said powders are acrylic powders used in paints to substantially reduce the use of surfactants in said paint.

31. The hydrophilic substrate layer obtained by sulfonation of claim 28, wherein said powders are acrylic powders used in concrete as retarders to reduce the use of surfactants in said concrete.
